(19) United States
(12) Patent Application Publication
(10) Pub. No.: US 2002/0173961 A1
(43) Pub. Date: Nov. 21, 2002

(54) System, method and computer program product for dynamic, robust and fault tolerant audio output in a speech recognition framework

(76) Inventor: Lisa M. Guerra, Los Altos, CA (US)

Correspondence Address: SILICON VALLEY INTELLECTUAL PROPERTY GROUP, P.O. BOX 721120, SAN JOSE, CA, 95172-1120, US

(21) Appl. No.: 09/802,393

(22) Filed: Mar. 9, 2001

(51) Int. Cl. G10L 13/00

(52) U.S. Cl. 704/258

(57) ABSTRACT

A system, method and computer program product are provided for enhanced speech synthesis. Initially, a string of words to be outputted is received. In response thereto, a database of words is queried to match the string of words for output purposes. If, however, no match is made, the string of words is parsed. The database of words is queried to match the parsed string of words for output purposes.

### FIELD OF THE INVENTION

The present invention relates to speech synthesis systems, and more particularly to enhancing text-to-speech synthesis.

### BACKGROUND OF THE INVENTION

Text-to-speech synthesis (TTS) is seen to be potentially useful to automate or create many information services. Unfortunately to date most commercial systems for automated synthesis remain too unnatural and machine-like for all but the simplest and shortest texts. Those systems have been described as sounding monotonous, boring, mechanical, harsh, disdainful, peremptory, fuzzy, muffled, choppy, and unclear. Synthesized isolated words are relatively easy to recognize, but when these are strung together into longer passages of connected speech (phrases or sentences) then it is much more difficult to follow the meaning.

Although there may be several possible reasons for segmental intelligibility failing to predict comprehension, there is a need of an improved voice synthesis system that addresses the single most likely cause: synthesis of the text's prosody. Prosody is the organization imposed onto a string of words when they are uttered as connected speech. It primarily involves pitch, duration, loudness, voice quality, tempo and rhythm. In addition, it modulates every known aspect of articulation. When the prosody is incorrect, then, at best, the speech will be difficult or impossible to understand, and at worst listeners will misunderstand it without being aware that they have done so.

There is thus a need for addressing the prosodic treatment of the text, and continuing to improve the quality of speech synthesis, especially in emerging applications utilizing speech recognition systems.

### DISCLOSURE OF THE INVENTION

A system, method and computer program product are provided for enhanced speech synthesis. Initially, a string of words to be outputted is received. In response thereto, a database of strings of words is queried to match the string of words for output purposes. If, however, no match is made, the string of words is parsed. The database of words is then queried to match the parsed string of words for output purposes.

In one embodiment of the present invention, the parsing may include removing one of the words. In a preferred embodiment, the removed word is the last word in the string of words. Moreover, the step of parsing and last querying step may be repeated until the string of words is matched in the database. By this design, the speech synthesis may be enhanced by ensuring that a largest pre-recorded audible recording is used for output purposes.

In another embodiment of the present invention, the string of words may be generated in response to the receipt of a request made by a user. Such request may be for any type of information such as stock quotes, entertainment information, driving directions, and flight information, etc. In response to the request for information or a service, a database look-up and processing may take place in order to generate the appropriate information in the form of the string of words. In other words, the string of words may be generated in the context of a speech recognition/synthesis system.

In one aspect of the present invention, the request for information or a service may be verbally made by utilizing a telephone, and the output may be transmitted utilizing the telephone. Further, the output may take the form of an audio file such as a wave file. In one embodiment, text-to-speech synthesis (TTS) may also be utilized for identifying any words not found in the database.

### BRIEF DESCRIPTION OF THE DRAWINGS

FIG. 1 illustrates an exemplary environment in which the present invention may be implemented;

FIG. 2 shows a representative hardware environment associated with the various components of FIG. 1;

FIG. 3 illustrates a method for enhanced speech synthesis, in accordance with one embodiment of the present invention;

FIG. 4 illustrates an example of the present invention; and

FIG. 5 is a schematic illustrating the manner in which VoiceXML functions, in accordance with one embodiment of the present invention.

### DESCRIPTION OF THE PREFERRED EMBODIMENTS

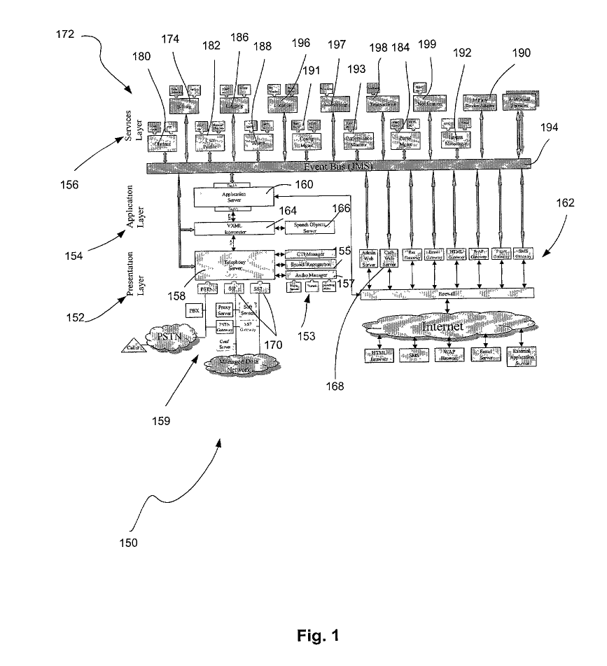

FIG. 1 illustrates one exemplary platform 150 on which the present invention may be implemented. The present platform 150 is capable of supporting voice applications that provide unique business services. Such voice applications may be adapted for consumer services or internal applications for employee productivity.

The present platform of FIG. 1 provides an end-to-end solution that manages a presentation layer 152, application logic 154, information access services 156, and telecom infrastructure 159. With the instant platform, customers can build complex voice applications through a suite of customized applications and a rich development tool set on an application server 160. The present platform 150 is capable of deploying applications in a reliable, scalable manner, and maintaining the entire system through monitoring tools.

The present platform 150 is multi-modal in that it facilitates information delivery via multiple mechanisms 162, i.e. Voice, Wireless Application Protocol (WAP), Hypertext Mark-up Language (HTML), Facsimile, Electronic Mail, Pager, and Short Message Service (SMS). It further includes a VoiceXML interpreter 164 that is fully compliant with the VoiceXML 1.0 specification, written entirely in Java®, and supports Nuance® SpeechObjects 166.

Yet another feature of the present platform 150 is its modular architecture, enabling “plug-and-play” capabilities. Still yet, the instant platform 150 is extensible in that developers can create their own custom services to extend the platform 150. For further versatility, Java® based components are supported that enable rapid development, reliability, and portability. Another web server 168 supports a web-based development environment that provides a comprehensive set of tools and resources which developers may need to create their own innovative speech applications.

Support for SIP and SS7 (Signaling System 7) is also provided. Backend Services 172 are also included that provide value added functionality such as content management 180 and user profile management 182. Still yet, there is support for external billing engines 174 and integration of leading edge technologies from Nuance®, Oracle®, Cisco®, Natural Microsystems®, and Sun Microsystems®.

More information will now be set forth regarding the application layer 154, presentation layer 152, and services layer 156.

### Application Layer (154)

The application layer 154 provides a set of reusable application components as well as the software engine for their execution. Through this layer, applications benefit from a reliable, scalable, and high performing operating environment. The application server 160 automatically handles lower level details such as system management, communications, monitoring, scheduling, logging, and load balancing. Some optional features associated with each of the various components of the application layer 154 will now be set forth.

### Application Server (160)

A high performance web/JSP server that hosts the business and presentation logic of applications.

High performance, load balanced, with failover.

Contains reusable application components and ready to use applications.

Hosts Java Servlets and JSP's for custom applications.

Provides easy to use taglib access to platform services.

### VXML Interpreter (164)

Executes VXML applications

VXML 1.0 compliant

Can execute applications hosted on either side of the firewall.

Extensions for easy access to system services such as billing.

Extensible—allows installation of custom VXML tag libraries and speech objects.

Provides access to SpeechObjects 166 from VXML.

Integrated with debugging and monitoring tools.

Written in Java®.

### Speech Objects Server (166)

Hosts SpeechObjects based components.

Provides a platform for running SpeechObjects based applications.

Contains a rich library of reusable SpeechObjects.

### Services Layer (156)

The services layer 156 simplifies the development of voice applications by providing access to modular value-added services. These backend modules deliver a complete set of functionality, and handle low level processing such as error checking. Examples of services include the content 180, user profile 182, billing 174, and portal management 184 services. By this design, developers can create high performing, enterprise applications without complex programming. Some optional features associated with each of the various components of the services layer 156 will now be set forth.

### Content (180)

Manages content feeds and databases such as weather reports, stock quotes, and sports.

Ensures content is received and processed appropriately.

Provides content only upon authenticated request.

Communicates with logging service 186 to track content usage for auditing purposes.

Supports multiple, redundant content feeds with automatic failover.

Sends alarms through alarm service 188.

### User Profile (182)

Manages user database

Can connect to a 3^{rd} party user database 190. For example, if a customer wants to leverage his/her own user database, this service will manage the connection to the external user database.

Provides user information upon authenticated request.

### Alarm (188)

Provides a simple, uniform way for system components to report a wide variety of alarms.

Allows for notification (Simply Network Management Protocol (SNMP), telephone, electronic mail, pager, facsimile, SMS, WAP push, etc.) based on alarm conditions.

Allows for alarm management (assignment, status tracking, etc.) and integration with trouble ticketing and/or helpdesk systems.

Allows for integration of alarms into customer premise environments.

### Configuration Management (191)

Maintains the configuration of the entire system.

### Performance Monitor (193)

Provides real time monitoring of entire system such as number of simultaneous users per customer, number of users in a given application, and the uptime of the system.

Enables customers to determine performance of system at any instance.

### Portal Management (184)

The portal management service 184 maintains information on the configuration of each voice portal and enables customers to electronically administer their voice portal through the administration web site.

Portals can be highly customized by choosing from multiple applications and voices. For example, a customer can configure different packages of applications i.e. a basic package consisting of 3 applications for $4.95, a deluxe package consisting of 10 applications for $9.95, and premium package consisting of any 20 applications for $14.95.

### Instant Messenger (192)

Detects when users are “on-line” and can pass messages such as new voicemails and e-mails to these users.

### Billing (174)

Provides billing infrastructure such as capturing and processing billable events, rating, and interfaces to external billing systems.

### Logging (186)

Logs all events sent over the JMS bus 194. Examples include User A of Company ABC accessed Stock Quotes, application server 160 requested driving directions from content service 180, etc.

### Location (196)

Provides geographic location of caller.

Location service sends a request to the wireless carrier or to a location network service provider such as TimesThree® or US Wireless. The network provider responds with the geographic location (accurate within 75 meters) of the cell phone caller.

### Advertising (197)

Administers the insertion of advertisements within each call. The advertising service can deliver targeted ads based on user profile information.

Interfaces to external advertising services such as Wyndwire® are provided.

### Transactions (198)

Provides transaction infrastructure such as shopping cart, tax and shipping calculations, and interfaces to external payment systems.

### Notification (199)

Provides external and internal notifications based on a timer or on external events such as stock price movements. For example, a user can request that he/she receive a telephone call every day at 8AM.

Services can request that they receive a notification to perform an action at a pre-determined time. For example, the content service 180 can request that it receive an instruction every night to archive old content.

### 3^{rd} Party Service Adapter (190)

Enables 3^{rd} parties to develop and use their own external services. For instance, if a customer wants to leverage a proprietary system, the 3^{rd} party service adapter can enable it as a service that is available to applications.

### Presentation Layer (152)

The presentation layer 152 provides the mechanism for communicating with the end user. While the application layer 154 manages the application logic, the presentation layer 152 translates the core logic into a medium that a user's device can understand. Thus, the presentation layer 152 enables multi-modal support. For instance, end users can interact with the platform through a telephone, WAP session, HTML session, pager, SMS, facsimile, and electronic mail. Furthermore, as new “touchpoints” emerge, additional modules can seamlessly be integrated into the presentation layer 152 to support them.

### Telephony Server (158)

The telephony server 158 provides the interface between the telephony world, both Voice over Internet Protocol (VoIP) and Public Switched Telephone Network (PSTN), and the applications running on the platform. It also provides the interface to speech recognition and synthesis engines 153. Through the telephony server 158, one can interface to other 3^{rd} party application servers 190 such as unified messaging and conferencing server. The telephony server 158 connects to the telephony switches and “handles” the phone call.

Features of the telephony server 158 include:

Mission critical reliability.

Suite of operations and maintenance tools.

Telephony connectivity via ISDN/T1/E1, SIP and SS7 protocols.

DSP-based telephony boards offload the host, providing real-time echo cancellation, DTMF & call progress detection, and audio compression/decompression.

### Speech Recognition Server (155)

The speech recognition server 155 performs speech recognition on real time voice streams from the telephony server 158. The speech recognition server 155 may support the following features:

Carrier grade scalability & reliability

Large vocabulary size

Industry leading speaker independent recognition accuracy

Recognition enhancements for wireless and hands free callers

Dynamic grammar support—grammars can be added during run time.

Multi-language support

Barge in—enables users to interrupt voice applications. For example, if a user hears “Please say a name of a football team that you, ” the user can interject by saying “Miami Dolphins” before the system finishes.

Speech objects provide easy to use reusable components

“On the fly” grammar updates

Speaker verification

### Audio Manager (157)

Manages the prompt server, text-to-speech server, and streaming audio.

### Prompt Server (153)

The Prompt server is responsible for caching and managing pre-recorded audio files for a pool of telephony servers.

### Text-to-Speech Server (153)

When pre-recorded prompts are unavailable, the text-to-speech server is responsible for transforming text input into audio output that can be streamed to callers on the telephony server 158. The use of the TTS server offloads the telephony server 158 and allows pools of TTS resources to be shared across several telephony servers.

Features include:

Support for industry leading technologies such as SpeechWorks® Speechify® and L&H RealSpeak®.

Standard Application Program Interface (API) for integration of other TTS engines.

### Streaming Audio

The streaming audio server enables static and dynamic audio files to be played to the caller. For instance, a one minute audio news feed would be handled by the streaming audio server.

Support for standard static file formats such as WAV and MP3

Support for streaming (dynamic) file formats such as Real Audio® and Windows® Media®.

### PSTN Connectivity

Support for standard telephony protocols like ISDN, E&M WinkStart®, and various flavors of E1 allow the telephony server 158 to connect to a PBX or local central office.

### SIP Connectivity

The platform supports telephony signaling via the Session Initiation Protocol (SIP). The SIP signaling is independent of the audio stream, which is typically provided as a G.711 RTP stream. The use of a SIP enabled network can be used to provide many powerful features including:

Flexible call routing

Call forwarding

Blind & supervised transfers

Location/presence services

Interoperable with SIP compliant devices such as soft switches

Direct connectivity to SIP enabled carriers and networks

Connection to SS7 and standard telephony networks (via gateways)

### Admin Web Server

Serves as the primary interface for customers.

Enables portal management services and provides billing and simple reporting information. It also permits customers to enter problem ticket orders, modify application content such as advertisements, and perform other value added functions.

Consists of a website with backend logic tied to the services and application layers. Access to the site is limited to those with a valid user id and password and to those coming from a registered IP address. Once logged in, customers are presented with a homepage that provides access to all available customer resources.

### Other (168)

Web-based development environment that provides all the tools and resources developers need to create their own speech applications.

Provides a VoiceXML Interpreter that is:

Compliant with the VoiceXML 1.0 specification.

Compatible with compelling, location-relevant SpeechObjects—including grammars for nationwide US street addresses.

Provides unique tools that are critical to speech application development such as a vocal player. The vocal player addresses usability testing by giving developers convenient access to audio files of real user interactions with their speech applications. This provides an invaluable feedback loop for improving dialogue design.

### WAP, HTML, SMS, Email, Pager, and Fax Gateways

Provide access to external browsing devices.

Manage (establish, maintain, and terminate) connections to external browsing and output devices.

Encapsulate the details of communicating with external device.

Support both input and output on media where appropriate. For instance, both input from and output to WAP devices.

Reliably deliver content and notifications.

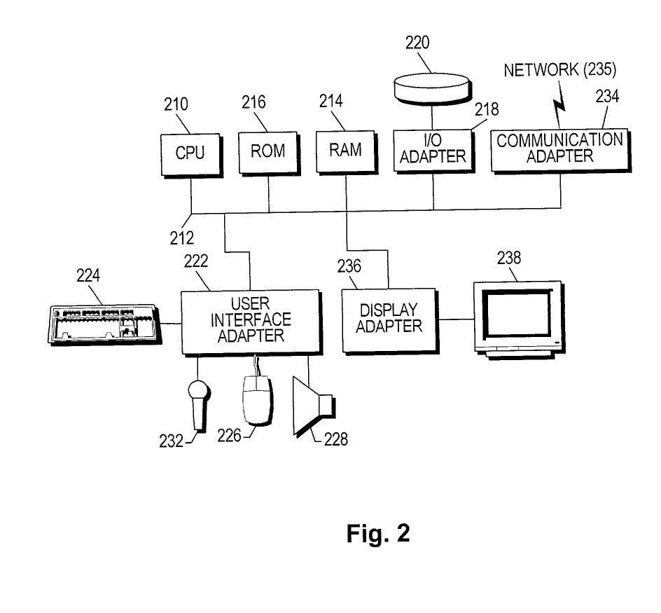

FIG. 2 shows a representative hardware environment associated with the various systems, i.e. computers, servers, etc., of FIG. 1. FIG. 2 illustrates a typical hardware configuration of a workstation in accordance with a preferred embodiment having a central processing unit 210, such as a microprocessor, and a number of other units interconnected via a system bus 212.

The workstation shown in FIG. 2 includes a Random Access Memory (RAM) 214, Read Only Memory (ROM) 216, an I/O adapter 218 for connecting peripheral devices such as disk storage units 220 to the bus 212, a user interface adapter 222 for connecting a keyboard 224, a mouse 226, a speaker 228, a microphone 232, and/or other user interface devices such as a touch screen (not shown) to the bus 212, communication adapter 234 for connecting the workstation to a communication network (e.g., a data processing network) and a display adapter 236 for connecting the bus 212 to a display device 238. The workstation typically has resident thereon an operating system such as the Microsoft Windows NT or Windows/95 Operating System (OS), the IBM OS/2 operating system, the MAC OS, or UNIX operating system. Those skilled in the art will appreciate that the present invention may also be implemented on platforms and operating systems other than those mentioned.

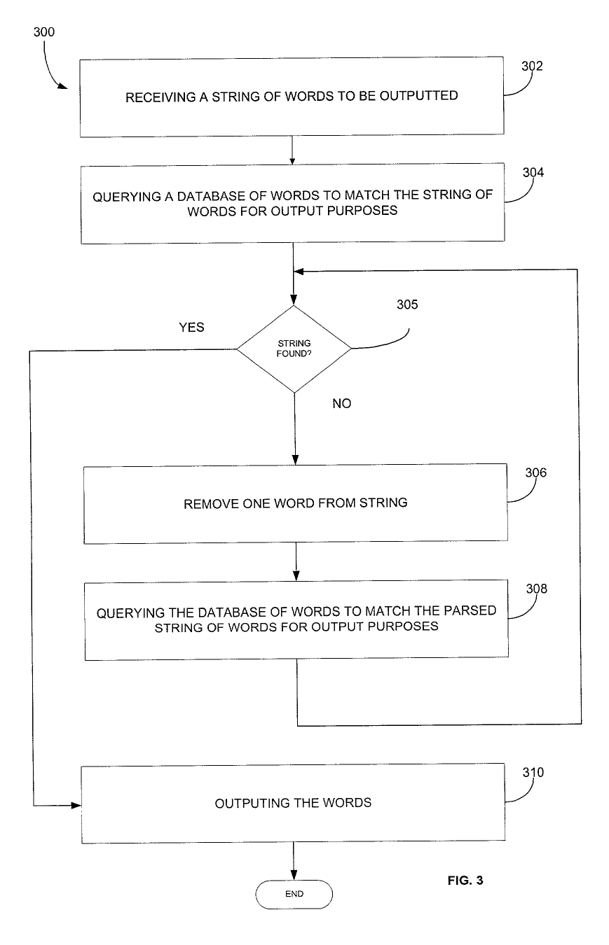

FIG. 3 illustrates a method 300 for enhanced speech synthesis. The present method may be carried utilizing the platform 150 and hardware set forth in FIGS. 1 and 2, and/or any other desired architecture.

Initially, a string of words to be outputted is received in operation 302. In one embodiment, the string of words may be generated by a speech recognition system in response to the receipt of a request made by a user. The speech recognition system of the present invention may provide a plurality of voice portal applications that can be personalized based on a caller's location, delivered to any device and customized via an open development platform.

Examples of various specific voice portal applications are set forth in Table 1. It should be noted that any services may be afforded per the desires of the user.

TABLE 1

| | |
|---|---|
| Nationwide Business Finder | search engine for locating businesses |
| | representing popular brands demanded |
| | by mobile consumers. |
| Nationwide Driving Directions | point-to-point driving directions |
| Worldwide Flight Information | up-to-the-minute flight information |
| | on major domestic and international |
| | carriers |
| Nationwide Traffic Updates | real-time traffic information for |
| | metropolitan areas |
| Worldwide Weather | updates and extended forecasts |
| | throughout the world |
| News | audio feeds providing the latest |
| | national and world headlines, as |
| | well as regular updates for business, |
| | technology, finance, sports, health |
| | and entertainment news |
| Sports | up-to-the-minute scores and highlights |
| | from the NFL, Major League Baseball, |
| | NHL, NBA, college football, basket- |
| | ball, hockey, tennis, auto racing, |
| | golf, soccer and boxing |
| Stock Quotes | access to major indices and all stocks |
| | on the NYSE, NASDAQ, and AMEX |
| | exchanges |
| Infotainment | updates on soap operas, television |
| | dramas, lottery numbers and horoscopes |

In response to the user request, a database look-up and processing may take place in order to generate the appropriate response in the form of a string of words. As such, a pre-recorded audible recording of the string of words may be outputted to the user upon a match being made.

In one embodiment, the pre-recorded audible recording of the string of words may take the form of a wave file. A wave file is an audio file format, created by Microsoft®, that has become a standard PC audio file format for everything from system and game sounds to CD-quality audio. A wave file is identified by a file name extension of WAV (.wav). Used primarily in PCs, the wave file format has been accepted as a viable interchange medium for other computer platforms, such as Macintosh®. This allows content developers to freely move audio files between platforms for processing, for example. In addition to the uncompressed raw audio data, the wave file format stores information about the file's number of tracks (mono or stereo), sample rate, and bit depth.

The pre-recorded audible recording of the string of words is retrieved from a database of wave or other type of files. This is accomplished by querying the database of words to match the string of words for output purposes. Note operation 304. It should be noted that the database of words includes a plethora of pre-recorded audible recordings representative of different words, and combinations of various numbers of such words. Of course, any other type of database may be utilized per the desires of the user.

After the query in operation 304, it is determined whether a string was found in decision 305. If not, at least one word is removed from the string of words in operation 306. This may be done by removing one or more words from a beginning or end of the string. Once removed, the database of words is again queried to match the new string of words of reduce sized. Note operation 308. The method is then returned to decision 305 in order to determine whether the new string has produced a match. If so, the pre-recorded audible recording representative of the string of words may be outputted to the user in operation 310.

The intent of this iteration is to ensure that a pre-recorded audible recording representative of a largest available combination of words is utilized. This is important for ensuring an output that exhibits a smooth transition between words, thereby providing output with higher quality, i.e. better rhythm, diction, prosody, etc. While it may be desired to include pre-recorded audible recordings for every combination of words regardless of length, the cost of building such a database must be weighed against the benefits of the present invention.

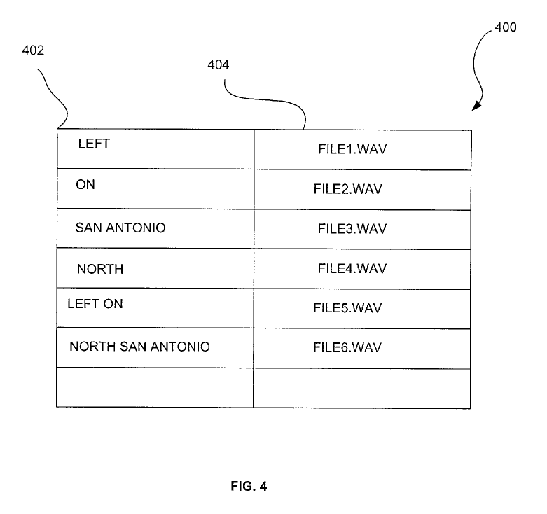

FIG. 4 illustrates an example of the present invention. As shown, a table 400 is shown to include a plurality of words and combinations thereof in a first column 402. Also included is a second column 404 including a plurality of pre-recorded audible recordings in the form of wave files each associated with one of the entries of the first column 402. In the present example, the aforementioned speech recognition system may be capable of outputting a string of words representative of driving directions. Once such string of words is received, they may be compared against the those in the first column 402 of the table 400 of FIG. 4.

In the present instance, it is assumed that the speech recognition system produces directions including “Turn Left on North San Antonio”. With reference again to FIG. 3, the table is queried in operation 304 for producing a match. As shown in FIG. 4, no match is possible, so a word may be removed from the beginning or end of the string. For example, “Turn” may be removed, leaving “Left on North San Antonio.” Again, no match is possible, so operations 306 and 308 may be repeated until “North San Antonio” is left at which time decision 305 will indicate that a match is found, and outputted.

At this point, it is evidenced that many variations of the instant method may be possible utilizing the foregoing principles. In particular, the remaining words “Turn,” “Left,” and “on” may be looked up separately, or in combination to further enhance the output of the present invention. Still yet, such parsing process may be implemented in parallel for expediency purposes. To this end, any desired parsing algorithm may be employed which enhances the output of the present invention.

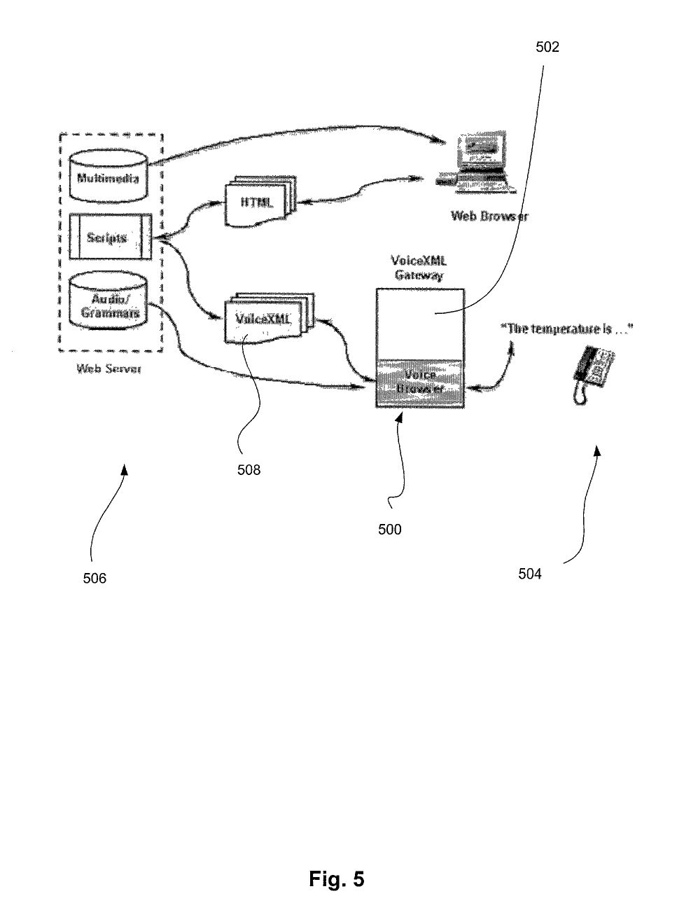

In one embodiment, at least a portion of the present invention may be implemented utilizing VoiceXML. FIG. 5 is a schematic illustrating the manner in which VoiceXML functions, in accordance with one embodiment of the present invention. A typical VoiceXML voice browser 500 of today runs on a specialized voice gateway node 502 that is connected both to the public switched telephone network 504 and to the Internet 506. As shown, VoiceXML 508 acts as an interface between the voice gateway node 502 and the Internet 506.

VoiceXML takes advantage of several trends:

The growth of the World-Wide Web and of its capabilities.

Improvements in computer-based speech recognition and text-to-speech synthesis.

The spread of the WWW beyond the desktop computer.

Voice application development is easier because VoiceXML is a high-level, domain-specific markup language, and because voice applications can now be constructed with plentiful, inexpensive, and powerful web application development tools.

VoiceXML is based on XML. XML is a general and highly flexible representation of any type of data, and various transformation technologies make it easy to map one XML structure to another, or to map XML into other data formats.

VoiceXML is an extensible markup language (XML) for the creation of automated speech recognition (ASR) and interactive voice response (IVR) applications. Based on the XML tag/attribute format, the VoiceXML syntax involves enclosing instructions (items) within a tag structure in the following manner:

<element_name attribute_name=“attribute_value”>

. . . . . . contained items . . . . . .

</element_name>

A VoiceXML application consists of one or more text files called documents. These document files are denoted by a “.vxml” file extension and contain the various VoiceXML instructions for the application. It is recommended that the first instruction in any document to be seen by the interpreter be the XML version tag:

<?xml version=“1.0”?>

The remainder of the document's instructions should be enclosed by the vxml tag with the version attribute set equal to the version of VoiceXML being used (“1.0” in the present case) as follows:

<vxml version=“1.0”>

Inside of the <vxml> tag, a document is broken up into discrete dialog elements called forms.

Each form has a name and is responsible for executing some portion of the dialog. For example, you may have a form called “mainMenu” that prompts the caller to make a selection from a list of options and then recognizes the response.

A form is denoted by the use of the <form> tag and can be specified by the inclusion of the id attribute to specify the form's name. This is useful if the form is to be referenced at some other point in the application or by another application. For example, <form id=“welcome”> would indicate in a VoiceXML document the beginning of the “welcome” form.

Following is a list of form items available in one specification of VoiceXML:

field items:

<field>—gathers input from the user via speech or DTMF recognition as defined by a grammar

<record>—records an audio clip from the user

<transfer>—transfers the user to another phone number

<object>—invokes a platform-specific object that may gather user input, returning the result as an ECMAScript object

<subdialog>—performs a call to another dialog or document(similar to a function call), returning the result as an ECMAScript object

control items:

<block>—encloses a sequence of statements for prompting and computation

<initial>—controls mixed-initiative interactions within a form

A preferred embodiment is written using JAVA, C, and the C++ language and utilizes object oriented programming methodology. Object oriented programming (OOP) has become increasingly used to develop complex applications. As OOP moves toward the mainstream of software design and development, various software solutions require adaptation to make use of the benefits of OOP. A need exists for these principles of OOP to be applied to a messaging interface of an electronic messaging system such that a set of OOP classes and objects for the messaging interface can be provided.

OOP is a process of developing computer software using objects, including the steps of analyzing the problem, designing the system, and constructing the program. An object is a software package that contains both data and a collection of related structures and procedures. Since it contains both data and a collection of structures and procedures, it can be visualized as a self-sufficient component that does not require other additional structures, procedures or data to perform its specific task. OOP, therefore, views a computer program as a collection of largely autonomous components, called objects, each of which is responsible for a specific task. This concept of packaging data, structures, and procedures together in one component or module is called encapsulation.

In general, OOP components are reusable software modules which present an interface that conforms to an object model and which are accessed at run-time through a component integration architecture. A component integration architecture is a set of architecture mechanisms which allow software modules in different process spaces to utilize each others capabilities or functions. This is generally done by assuming a common component object model on which to build the architecture. It is worthwhile to differentiate between an object and a class of objects at this point. An object is a single instance of the class of objects, which is often just called a class. A class of objects can be viewed as a blueprint, from which many objects can be formed.

OOP allows the programmer to create an object that is a part of another object. For example, the object representing a piston engine is said to have a composition-relationship with the object representing a piston. In reality, a piston engine comprises a piston, valves and many other components; the fact that a piston is an element of a piston engine can be logically and semantically represented in OOP by two objects.

OOP also allows creation of an object that “depends from” another object. If there are two objects, one representing a piston engine and the other representing a piston engine wherein the piston is made of ceramic, then the relationship between the two objects is not that of composition. A ceramic piston engine does not make up a piston engine. Rather it is merely one kind of piston engine that has one more limitation than the piston engine; its piston is made of ceramic. In this case, the object representing the ceramic piston engine is called a derived object, and it inherits all of the aspects of the object representing the piston engine and adds further limitation or detail to it. The object representing the ceramic piston engine “depends from” the object representing the piston engine. The relationship between these objects is called inheritance.

When the object or class representing the ceramic piston engine inherits all of the aspects of the objects representing the piston engine, it inherits the thermal characteristics of a standard piston defined in the piston engine class. However, the ceramic piston engine object overrides these ceramic specific thermal characteristics, which are typically different from those associated with a metal piston. It skips over the original and uses new functions related to ceramic pistons. Different kinds of piston engines have different characteristics, but may have the same underlying functions associated with it (e.g., how many pistons in the engine, ignition sequences, lubrication, etc.). To access each of these functions in any piston engine object, a programmer would call the same functions with the same names, but each type of piston engine may have different/overriding implementations of functions behind the same name. This ability to hide different implementations of a function behind the same name is called polymorphism and it greatly simplifies communication among objects.

With the concepts of composition-relationship, encapsulation, inheritance and polymorphism, an object can represent just about anything in the real world. In fact, one's logical perception of the reality is the only limit on determining the kinds of things that can become objects in object-oriented software. Some typical categories are as follows:

Objects can represent physical objects, such as automobiles in a traffic-flow simulation, electrical components in a circuit-design program, countries in an economics model, or aircraft in an air-traffic-control system.

Objects can represent elements of the computer-user environment such as windows, menus or graphics objects.

An object can represent an inventory, such as a personnel file or a table of the latitudes and longitudes of cities.

An object can represent user-defined data types such as time, angles, and complex numbers, or points on the plane.

With this enormous capability of an object to represent just about any logically separable matters, OOP allows the software developer to design and implement a computer program that is a model of some aspects of reality, whether that reality is a physical entity, a process, a system, or a composition of matter. Since the object can represent anything, the software developer can create an object which can be used as a component in a larger software project in the future.

If 90% of a new OOP software program consists of proven, existing components made from preexisting reusable objects, then only the remaining 10% of the new software project has to be written and tested from scratch. Since 90% already came from an inventory of extensively tested reusable objects, the potential domain from which an error could originate is 10% of the program. As a result, OOP enables software developers to build objects out of other, previously built objects. This process closely resembles complex machinery being built out of assemblies and sub-assemblies. OOP technology, therefore, makes software engineering more like hardware engineering in that software is built from existing components, which are available to the developer as objects. All this adds up to an improved quality of the software as well as an increased speed of its development.

Programming languages are beginning to fully support the OOP principles, such as encapsulation, inheritance, polymorphism, and composition-relationship. With the advent of the C++ language, many commercial software developers have embraced OOP. C++ is an OOP language that offers a fast, machine-executable code. Furthermore, C++ is suitable for both commercial-application and systems-programming projects. For now, C++ appears to be the most popular choice among many OOP programmers, but there is a host of other OOP languages, such as Smalltalk, Common Lisp Object System (CLOS), and Eiffel. Additionally, OOP capabilities are being added to more traditional popular computer programming languages such as Pascal.

The benefits of object classes can be summarized, as follows:

Objects and their corresponding classes break down complex programming problems into many smaller, simpler problems.

Encapsulation enforces data abstraction through the organization of data into small, independent objects that can communicate with each other. Encapsulation protects the data in an object from accidental damage, but allows other objects to interact with that data by calling the object's member functions and structures.

Subclassing and inheritance make it possible to extend and modify objects through deriving new kinds of objects from the standard classes available in the system. Thus, new capabilities are created without having to start from scratch.

Polymorphism and multiple inheritance make it possible for different programmers to mix and match characteristics of many different classes and create specialized objects that can still work with related objects in predictable ways.

Class hierarchies and containment hierarchies provide a flexible mechanism for modeling real-world objects and the relationships among them.

Libraries of reusable classes are useful in many situations, but they also have some limitations. For example:

Complexity. In a complex system, the class hierarchies for related classes can become extremely confusing, with many dozens or even hundreds of classes.

Flow of control. A program written with the aid of class libraries is still responsible for the flow of control (i.e., it must control the interactions among all the objects created from a particular library). The programmer has to decide which functions to call at what times for which kinds of objects.

Duplication of effort. Although class libraries allow programmers to use and reuse many small pieces of code, each programmer puts those pieces together in a different way. Two different programmers can use the same set of class libraries to write two programs that do exactly the same thing but whose internal structure (i.e., design) may be quite different, depending on hundreds of small decisions each programmer makes along the way. Inevitably, similar pieces of code end up doing similar things in slightly different ways and do not work as well together as they should.

Class libraries are very flexible. As programs grow more complex, more programmers are forced to reinvent basic solutions to basic problems over and over again. A relatively new extension of the class library concept is to have a framework of class libraries. This framework is more complex and consists of significant collections of collaborating classes that capture both the small-scale patterns and major mechanisms that implement the common requirements and design in a specific application domain. They were first developed to free application programmers from the chores involved in displaying menus, windows, dialog boxes, and other standard user interface elements for personal computers.

Frameworks also represent a change in the way programmers think about the interaction between the code they write and code written by others. In the early days of procedural programming, the programmer called libraries provided by the operating system to perform certain tasks, but basically the program executed down the page from start to finish, and the programmer was solely responsible for the flow of control. This was appropriate for printing out paychecks, calculating a mathematical table, or solving other problems with a program that executed in just one way.

The development of graphical user interfaces began to turn this procedural programming arrangement inside out. These interfaces allow the user, rather than program logic, to drive the program and decide when certain actions should be performed. Today, most personal computer software accomplishes this by means of an event loop which monitors the mouse, keyboard, and other sources of external events and calls the appropriate parts of the programmer's code according to actions that the user performs. The programmer no longer determines the order in which events occur. Instead, a program is divided into separate pieces that are called at unpredictable times and in an unpredictable order. By relinquishing control in this way to users, the developer creates a program that is much easier to use. Nevertheless, individual pieces of the program written by the developer still call libraries provided by the operating system to accomplish certain tasks, and the programmer must still determine the flow of control within each piece after it's called by the event loop. Application code still “sits on top of” the system.

Even event loop programs require programmers to write a lot of code that should not need to be written separately for every application. The concept of an application framework carries the event loop concept further. Instead of dealing with all the nuts and bolts of constructing basic menus, windows, and dialog boxes and then making these things all work together, programmers using application frameworks start with working application code and basic user interface elements in place. Subsequently, they build from there by replacing some of the generic capabilities of the framework with the specific capabilities of the intended application.

Application frameworks reduce the total amount of code that a programmer has to write from scratch. However, because the framework is really a generic application that displays windows, supports copy and paste, and so on, the programmer can also relinquish control to a greater degree than event loop programs permit. The framework code takes care of almost all event handling and flow of control, and the programmer's code is called only when the framework needs it (e.g., to create or manipulate a proprietary data structure).

A programmer writing a framework program not only relinquishes control to the user (as is also true for event loop programs), but also relinquishes the detailed flow of control within the program to the framework. This approach allows the creation of more complex systems that work together in interesting ways, as opposed to isolated programs, having custom code, being created over and over again for similar problems. Thus, as is explained above, a framework basically is a collection of cooperating classes that make up a reusable design solution for a given problem domain. It typically includes objects that provide default behavior (e.g., for menus and windows), and programmers use it by inheriting some of that default behavior and overriding other behavior so that the framework calls application code at the appropriate times.

There are three main differences between frameworks and class libraries:

Behavior versus protocol. Class libraries are essentially collections of behaviors that you can call when you want those individual behaviors in your program. A framework, on the other hand, provides not only behavior but also the protocol or set of rules that govern the ways in which behaviors can be combined, including rules for what a programmer is supposed to provide versus what the framework provides.

Call versus override. With a class library, the code the programmer instantiates objects and calls their member functions. It's possible to instantiate and call objects in the same way with a framework (i.e., to treat the framework as a class library), but to take full advantage of a framework's reusable design, a programmer typically writes code that overrides and is called by the framework. The framework manages the flow of control among its objects. Writing a program involves dividing responsibilities among the various pieces of software that are called by the framework rather than specifying how the different pieces should work together.

Implementation versus design. With class libraries, programmers reuse only implementations, whereas with frameworks, they reuse design. A framework embodies the way a family of related programs or pieces of software work. It represents a generic design solution that can be adapted to a variety of specific problems in a given domain. For example, a single framework can embody the way a user interface works, even though two different user interfaces created with the same framework might solve quite different interface problems.

Thus, through the development of frameworks for solutions to various problems and programming tasks, significant reductions in the design and development effort for software can be achieved. A preferred embodiment of the invention utilizes HyperText Markup Language (HTML) to implement documents on the Internet together with a general purpose secure communication protocol for a transport medium between the client and the Newco. HTTP or other protocols could be readily substituted for HTML without undue experimentation. Information on these products is available in T. Berners-Lee, D. Connoly, “RFC 1866: Hypertext Markup Language—2.0” (Nov. 1995); and R. Fielding, H, Frystyk, T. Berners-Lee, J. Gettys and J. C. Mogul, “Hypertext Transfer Protocol—HTTP/1.1: HTTP Working Group Internet Draft” (May 2, 1996). HTML is a simple data format used to create hypertext documents that are portable from one platform to another. HTML documents are SGML documents with generic semantics that are appropriate for representing information from a wide range of domains. HTML has been in use by the World-Wide Web global information initiative since 1990. HTML is an application of ISO Standard 8879; 1986 Information Processing Text and Office Systems; Standard Generalized Markup Language (SGML).

To date, Web development tools have been limited in their ability to create dynamic Web applications which span from client to server and interoperate with existing computing resources. Until recently, HTML has been the dominant technology used in development of Web-based solutions. However, HTML has proven to be inadequate in the following areas:

Poor performance;

Restricted user interface capabilities;

Can only produce static Web pages;

Lack of interoperability with existing applications and data; and

Inability to scale.

Sun Microsystem's Java language solves many of the client-side problems by:

Improving performance on the client side;

Enabling the creation of dynamic, real-time Web applications; and

Providing the ability to create a wide variety of user interface components.

With Java, developers can create robust User Interface (UI) components. Custom “widgets” (e.g., real-time stock tickers, animated icons, etc.) can be created, and client-side performance is improved. Unlike HTML, Java supports the notion of client-side validation, offloading appropriate processing onto the client for improved performance. Dynamic, real-time Web pages can be created. Using the above-mentioned custom UI components, dynamic Web pages can also be created.

Sun's Java language has emerged as an industry-recognized language for “programming the Internet.” Sun defines Java as: “a simple, object-oriented, distributed, interpreted, robust, secure, architecture-neutral, portable, high-performance, multithreaded, dynamic, buzzword-compliant, general-purpose programming language. Java supports programming for the Internet in the form of platform-independent Java applets.” Java applets are small, specialized applications that comply with Sun's Java Application Programming Interface (API) allowing developers to add “interactive content” to Web documents (e.g., simple animations, page adornments, basic games, etc.). Applets execute within a Java-compatible browser (e.g., Netscape Navigator) by copying code from the server to client. From a language standpoint, Java's core feature set is based on C++. Sun's Java literature states that Java is basically, “C++ with extensions from Objective C for more dynamic method resolution.”

Another technology that provides similar function to JAVA is provided by Microsoft and ActiveX Technologies, to give developers and Web designers wherewithal to build dynamic content for the Internet and personal computers. ActiveX includes tools for developing animation, 3-D virtual reality, video and other multimedia content. The tools use Internet standards, work on multiple platforms, and are being supported by over 100 companies. The group's building blocks are called ActiveX Controls, small, fast components that enable developers to embed parts of software in hypertext markup language (HTML) pages. ActiveX Controls work with a variety of programming languages including Microsoft Visual C++, Borland Delphi, Microsoft Visual Basic programming system and, in the future, Microsoft's development tool for Java, code named “Jakarta.” ActiveX Technologies also includes ActiveX Server Framework, allowing developers to create server applications. One of ordinary skill in the art readily recognizes that ActiveX could be substituted for JAVA without undue experimentation to practice the invention.

While various embodiments have been described above, it should be understood that they have been presented by way of example only, and not limitation. Thus, the breadth and scope of a preferred embodiment should not be limited by any of the above-described exemplary embodiments, but should be defined only in accordance with the following claims and their equivalents.

What is claimed is:

1. A method for enhanced speech synthesis, comprising the steps of:
(a) receiving a string of words to be outputted;
(b) querying a database of strings of words to match the string of words for output purposes;
(c) parsing the string of words if no match is made in step (b); and
(d) querying the database of words to match the parsed string of words for output purposes.

2. The method as recited in claim 1, wherein the parsing includes removing one of the words.

3. The method as recited in claim 2, wherein steps (c) and (d) are repeated until the string of words is matched in the database.

4. The method as recited in claim 3, wherein a pre-recorded audible recording of the string of words is outputted to a user upon a match being made.

5. The method as recited in claim 4, wherein the speech synthesis is enhanced by ensuring that a largest pre-recorded audible recording is used for output purposes.

6. The method as recited in claim 1, wherein the string of words is received utilizing a network.

7. The method as recited in claim 6, wherein the network includes the Internet.

8. The method as recited in claim 1, wherein the string of words includes an address.

9. The method as recited in claim 8, wherein the string of words includes driving directions.

10. The method as recited in claim 1, wherein the string of words is generated in response to receipt of a request made by a user.

11. The method as recited in claim 10, wherein the request is made by the user verbally utilizing a telephone, and recognized utilizing a speech recognition framework.

12. The method as recited in claim 11, wherein the output is transmitted utilizing the telephone.

13. The method as recited in claim 1, wherein the output includes an audio file.

14. The method as recited in claim 1, wherein the string of words represent entities selected from the group consisting of stock quotes, entertainment information, driving directions, and flight information.

15. The method as recited in claim 1, wherein text-to-speech synthesis (TTS) is utilized for identifying any words not found in the database.

16. A computer program product for enhanced speech synthesis, comprising:
(a) computer code for receiving a string of words to be outputted;
(b) computer code for querying a database of words to match the string of words for output purposes;
(c) computer code for parsing the string of words if no match is made by code segment (b); and
(d) computer code for querying the database of words to match the parsed string of words for output purposes.

17. A system for enhanced speech synthesis, comprising:
(a) logic for receiving a string of words to be outputted;
(b) logic for querying a database of words to match the string of words for output purposes;
(c) logic for parsing the string of words if no match is made by logic segment (b); and
(d) logic for querying the database of words to match the parsed string of words for output purposes.
